(19) United States
(12) Patent Application Publication
(10) Pub. No.: US 2025/0153112 A1
(43) Pub. Date: May 15, 2025

(54) THREE-DIMENSIONAL FILTRATION COMPOSITES AND METHODS OF MANUFACTURING

(71) Applicants: Lawrence Livermore National Laboratory, Livermore, CA (US); The Board of Trustees of the University of Illinois, Urbana, IL (US)

(72) Inventors: Juergen BIENER, Castro Valley, CA (US); Jianchao YE, Tracy, CA (US); Sangil KIM, Chicago, IL (US)

(21) Appl. No.: 18/509,697

(22) Filed: Nov. 15, 2023

(51) Int. Cl. B01D 67/00; B01D 69/02; B01D 71/02; B01D 71/40; B33Y 10/00; B33Y 80/00

(52) U.S. Cl. CPC B01D 67/00045; B01D 67/00415; B01D 67/0083; B01D 69/02; B01D 71/022; B01D 71/401; B01D 2323/18; B01D 2325/02832; B01D 2325/02833; B01D 2325/02834; B01D 2325/08; B01D 2325/54; B33Y 10/00; B33Y 80/00

(57) ABSTRACT

Material processing composites, devices, methods of use, and methods of manufacturing using composites having three-dimensional interpenetrating channels separated by porous walls. Such composites include composites having a first flow channel and a second flow channel defined and separated by porous (e.g., nanoporous) walls, wherein the first flow channel and the second flow channels have a three-dimensional interpenetrating structure. The first flow channel and the second flow channel may have a triply periodic minimal surface structure, such as a gyroid or Schwartz surface structure. In some embodiments, the composite is configured for use in hemofiltration, molecular filtration, gas purification, energy storage, or chemical conversion.

### FEDERALLY SPONSORED RESEARCH OR DEVELOPMENT

This technology was made with Government support under Contract No. DE-AC52-07NA27344 awarded by the United States Department of Energy. The Government has certain rights in the invention.

### FIELD

The present technology relates to composites, devices, and methods for transport of a component from one liquid or gas material stream to another liquid or gas material stream, as well as methods of manufacturing such composites. Such technology includes compositions and methods for filtering liquid and gaseous materials, such as removing undesired components from biological materials (e.g., hemodialysis) and combustion gas streams (e.g., separation of carbon dioxide from combustion gasses), extracting materials (e.g., rare earth metals) from source materials, and enabling reactions between components of liquid and gas streams.

### BACKGROUND

Many material processing and reaction methods require filtering, isolation or other transfer of one or more chemicals or other materials from a liquid or gas. For example, filtration may be employed to remove undesired components from biological materials (as in hemodialysis) or from industrial effluents (e.g., removal of carbon dioxide from combustion products).

In various contexts, such processing may be accomplished using porous membrane technology. The ideal characteristics of membranes used for transport or other filtering of materials include: (1) high porosity and high membrane surface area per packing volume for high hydraulic permeance allowing for high filtration/separation rates; (2) narrow pore size distribution for high selectivity; (3) thin membrane and low-tortuosity pore structure to minimize adsorption of solutes in membrane pore which may cause significant loss of low abundance species; and (4) excellent anti-fouling properties to prevent membrane clogging (in systems where clogging is a concern).

A wide variety of physiological processes involve filtration, using complex three-dimensional (3D) membrane architecture that provides both high flux and high selectivity. For example, the glomerular filtration rate in the kidneys of an average 70 kg adult is about 180 L/day of glomerular filtrate. The high filtration rate is driven by hydrostatic pressure and enabled by the unique 3D morphology of the glomerulus which is comprised of bundles of capillaries with 645 cm² of filtration area per 100 cm² of projected area.

By contrast, the morphology of man-made commercial membranes is still based on thick two-dimensional (2D) structures with broad pore size distribution and long tortuous pore geometries. These limitations result in low filtration and purification efficiency due to low selectivity and permeability, limiting the use or effectiveness of filtration technologies known in the art.

For example, current polymeric membrane based hemodialysis systems (i.e., Renal Assist Device, RAD) using 2D filtration structures require an extracorporeal circuit with peristaltic pumps to provide enough driving pressure for the hemofiltration which makes the system bulky and prevents the development of miniaturized and implantable RADs for end-stage renal disease in active young children. Further, current polymeric membrane based hemodialysis systems are susceptible to fouling caused by the adsorption of proteins on the membrane surface.

Another area of significant commercial interest for filtration technologies is the separation of CO₂ (carbon dioxide) from combustion waste streams, both to reduce the levels of atmospheric “greenhouse” gasses and as a source of CO₂ for electrochemical synthesis of commodity chemicals. While CO₂ separation at industrial scale has been demonstrated, the current wet scrubbing technology reduces the energy efficiency of power plants by roughly 30%, thus preventing widespread use of this technology. Membrane contactors promise to make CO₂ absorption more energy efficient by increasing the CO₂ loading of the liquid absorber through optimization of the contact between the CO₂ containing feed gas and a liquid absorbent. However, current 2D or one-dimensional filter technologies limit the ability to remove carbon dioxide (CO₂) from fossil fuel combustion streams.

Accordingly, there is a need for improved filtration and material processing devices and methods in the art, providing such benefits as improved filtration rates, increased selectivity, reduced adsorption of solutes in pores, and resistance to fouling. For example, such improvements may afford greater filtration efficiency, improving the economic viability of filtration-based technologies and allowing use of filtration technologies in applications having size constraints or where portability is desired.

### SUMMARY

In various embodiments, the present technology provides material processing composites, devices, methods of use, and methods of manufacturing using composites having three-dimensional interpenetrating channels separated by porous walls. Such composites include composites having a first flow channel and a second flow channel defined and separated by porous (e.g., nanoporous) walls, wherein the first flow channel and the second flow channels have a three-dimensional interpenetrating structure. The first flow channel and the second flow channel have a triply periodic minimal surface structure, such as a gyroid, double gyroid, Schwartz, kelvin foam, octet truss, Kagome lattice, Neovice, N14, N26, N38, diamond, or double diamond surface structure. In some embodiments, the composite is configured for use in hemofiltration, molecular filtration, gas purification, energy storage, or chemical conversion.

In some embodiments, at least one of the first flow channel and the second flow channel has a cross sectional diameter of from about 10 μm to about 1,000 μm, or from about 50 μm to about 500 μm. The porous walls may comprise a plurality of pores having a pore size of from about 0.003 μm to about 1 μm.

In various embodiments, the porous walls comprise a polymer, metal or ceramic. For example, porous walls may comprise an acrylate, methacrylate polymer, acetate polymer or combinations thereof, such as a polymer selected from the group consisting of 1,6-hexane diacrylate polymer, carboxybetaine-dimethacrylate polymer, pentaerythirotal triacetate polymer, and combinations thereof.

The present technology also provides filtration devices for filtering mixtures comprising component materials. Such devices comprise a composite of the present technology; a mixture source in communication with the first flow channel; and a component material collection media source in fluid communication with the second flow channel; wherein the porous walls are operable to selectively permit flow of the component material from the mixture.

The present technology also provides methods for making a material processing composite having a three-dimensional interpenetrating structure including a first flow channel and a second flow channel defined and separated by porous walls, the method comprising forming the porous walls by an additive printing process using a substrate ink. The additive printing process may comprise projection micro stereolithography, direct ink writing, selective laser sintering, selective laser melting, or powder bed three-dimensional printing. In various embodiments, methods further comprise forming pores in the porous walls through polymerization induced phase separation. For example, the substrate ink may comprise a monomer and a porogen, wherein the forming comprises printing a wall structure using the additive printing process; curing the wall structure to form a cured structure; and extracting the porogen from the cured structure to form the porous walls.

### BRIEF DESCRIPTION OF THE DRAWINGS

The drawings described in this disclosure depict non-limiting exemplary embodiments of seals that may be made using the compositions of the present technology. In particular:

FIG. 1 is a perspective diagram of a composite of the present technology, comprising a three-dimensional, periodic structure having interpenetrating wall portions, in the form of a gyroid;

FIG. 2 is a flow chart for a method of manufacturing of the present technology;

FIG. 3 is a is a flow chart for a method of manufacturing of the present technology;

FIG. 4A is a perspective diagram of a composite of the present technology;

FIG. 4b is a cross section diagram of a composite of the present technology; and

FIG. 5 shows three photomicrographs of a composite of the present technology.

It should be noted that the figures are intended to exemplify the general characteristics of compositions and processes among those of this present technology. The figures may not precisely reflect the characteristics of any given embodiment and are not necessarily intended to define or limit specific embodiments within the scope of the subject technology. Corresponding reference numerals indicate corresponding parts throughout the several views of the drawings.

### DETAILED DESCRIPTION

The following description of technology is merely exemplary in nature of the subject matter of one or more inventions, and is not intended to limit the scope, application, or uses of any specific invention claimed in this application or in such other applications as may be filed claiming priority to this application, or patents issuing therefrom. A non-limiting discussion of terms and phrases intended to aid understanding of the present technology is provided at the end of this Detailed Description.

### Filtration Composites

The present technology provides material constructs, herein “filtration composites” or “composites,” useful in a wide variety of processes where filtration, isolation, separation or other transfer of materials from a composition or between compositions is desired, such processes generally referred to as “filtration” or “transfer” herein (without limitation of utility) as further described below, it being understood that such “composites” may comprise one or more materials in a homogenous or heterogenous composition (and not necessarily a mixture of materials). In general, filtration composites may be adapted or configured to have specific physical and chemical characteristics for the intended end-use application, e.g., to improve selective filtration of components from a mixture. In various aspects, the operability of the filtration composites may be affected by the composition of the materials comprising the filtration composites, the physical architecture of the composite, and the method by which the filtration composite is made. In various embodiments, as described further herein, composites of the present technology are configured so as to provide cross-flow filtration or mixing of a liquid or gas in the first channel with a liquid or gas in the second channel.

### Composite Architecture

The filtration composites of the present technology can be generally characterized as having flow channels (preferably two) separated by a porous wall, wherein the wall is operable to selectively permit the flow of one or more components from a liquid or gas stream in one flow channel to a liquid or gas stream in a second flow channel. In various embodiments, composites consist essentially of two flow channels, i.e., not having three or more flow channels, without limitation as to the composition of the composite or the existence of other features.

Without limiting the scope or function of the present technology, in various aspects the porous wall may be characterized as a porous membrane, analogous to physiological systems for isolation or filtration of biologic materials. Composites of the present technology may comprise two independent but interpenetrating macropore flow channel systems separated by a thin nano-porous wall. Such composites may comprise a first flow channel and a second flow channel defined and separated by porous (e.g., nanoporous) walls, wherein the first flow channel and the second flow channels have a three-dimensional (“3D”) interpenetrating structure.

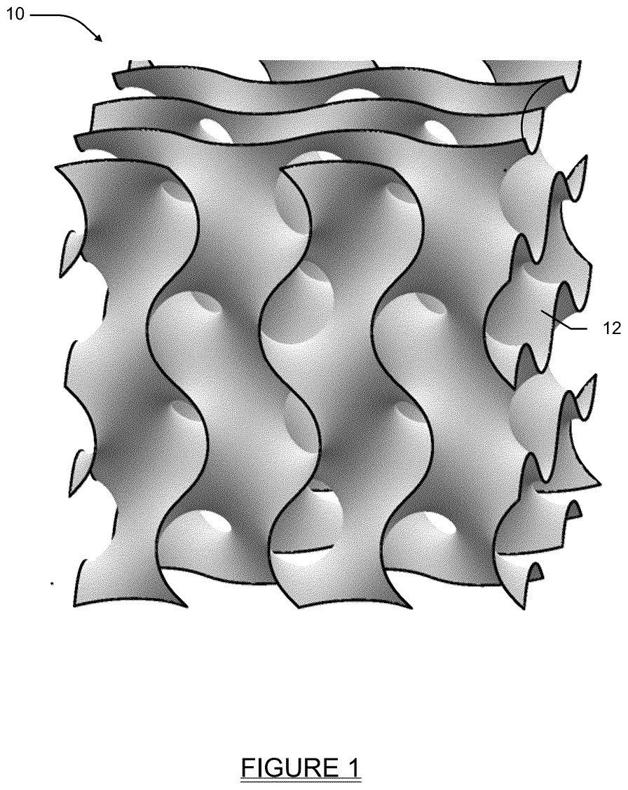

FIG. 1 depicts a simplified representation of a 3D composite 10 having interpenetrating layer portions. In this example, the structure 10 takes the form of a gyroid. However, the 3D structure 10 of FIG. 1 includes 3D surface wall portions 12 which are formed relative to one another to be interpenetrating. As used herein, “interpenetrating” means that one wall portion 12 cannot be disengaged from the other by any combination of translations or rotations. That is, in order to separate the two wall portions, which are not connected, one of the wall portions must be cut.

More generally, the 3D interpenetrating structure may be periodic or aperiodic, ordered or disordered. In various aspects, the structure is interpenetrating and three-dimensional for all of the materials being used to form the structure.

In various embodiments, composites comprise triply periodic minimal surfaces (TPMS). Such TPMS structures locally minimize surface areas for a given boundary, comprising infinite, non-self-intersecting, periodic surfaces in three dimensions. In various aspects, the 3D surfaces used for patterning may be parametric. For example, composites may have a gyroid surface, the boundaries of which can be defined by the equations:

$$sin ( 2 ⋆ pi ⋆ x / L ) ⋆ cos ( 2 ⋆ pi ⋆ y / L ) + sin ( 2 ⋆ pi ⋆ y / L ) ⋆ cos ( 2 ⋆ pi ⋆ z / L ) + sin ( 2 ⋆ pi ⋆ z / L ) ⋆ cos ( 2 ⋆ pi ⋆ x / L ) = + t / 2$$

$$and$$

$$sin ( 2 ⋆ pi ⋆ x / L ) ⋆ cos ( 2 ⋆ pi ⋆ y / L ) + sin ( 2 ⋆ pi ⋆ y / L ) ⋆ cos ( 2 ⋆ pi ⋆ z / L ) + sin ( 2 ⋆ pi ⋆ z / L ) ⋆ cos ( 2 ⋆ pi ⋆ x / L ) = - t / 2 [ 6 ] ,$$

so that the thickness of the gyroid is the parameter “t” and its period (i.e., the length of a unit cell) is “L”.

In various embodiments, composites have triply periodic structures such as gyroids, double gyroid, and Schwarz minimal surfaces (e.g., Schwartz P surface and Schwartz D surface). Other examples include Neovius surfaces, N14 surfaces, N26 surfaces, N38 surfaces, diamond surfaces, double diamond surfaces, Kelvin foam surfaces, octet truss surfaces, and Kagome lattice surfaces. The present disclosure may make use of any of the foregoing surfaces discussed or surfaces among those described at: http: www.susqu.edu/brake/evolver/examples/periodic/periodic.html. Structures among those useful herein are depicted in U.S. Pat. No. 11,309,574, Duoss, et al., issued Apr. 19, 2022, the disclosure of which is incorporated herein by reference.

In various embodiments, the porous walls have a thickness of from about 5 μm to about 1,000 μm, or from about 10 μm to about 500 μm, or from about 10 μm to about 100 μm. The composite structures may be characterized by a flow channel diameter (i.e., cross-sectional dimension) and a porous wall pore diameter. The selection of these dimensions may depend on the intended end-use application of the composite.

In various embodiments, at least one of the first flow channel and the second flow channel has a cross sectional diameter of from about 1 μm to about 10,000 μm, or from about 5 μm to about 5,000 μm, or from about 10 μm to about 1,000 μm, or from about 50 μm to about 500 μm. In various embodiments, the diameter of flow channels may be from about 1 micron to about 500 microns, or from 20 to about 200 microns, or from about 50 to about 100 microns.

In many embodiments, small diameter flow channels may be preferred, to increase the flow channel surface area per volume of the composite, affording a greater membrane packing density. In some aspects, composites for use with heterogenous media (e.g., blood) have a flow channel diameter that is about 10 times the largest dimension of the particles (e.g. cells) suspended in the media. Thus, for composites operable for the flow of blood through a flow channel, the diameter of the flow channel may be about 200 microns, i.e. about 10 times the size of monocytes (which are about 20 microns in diameter). In some embodiments for composites operable for the flow of gases or low viscosity liquids, flow channels have smaller diameters, e.g., about 100 microns, to increase packing density.

In general, composites may comprise porous walls that are microporous, mesoporous, or macroporous. As referred to herein, “macropores: have an average diameter of greater than about 50 nanometer, whereas “mesopores” have an average diameter of from about 2 to about 50 nanometers, and “micropores” have an average diameter less than about 2 nanometers. As referred to herein, “nanopores” have an average diameter less than 1 μm and greater than 0.01 nanometers. It should be understood, however, that these ranges are approximate and may overlap, e.g., a large nanopore may also be defined as a small micropore.

In various embodiments, the porous walls comprise a plurality of pores having a pore size of from about 0.001 μm to about 5 μm, or from about 0.003 μm to about 1 μm, or from about 0.003 μm to about 0.5 μm. In embodiments where pores provide selectivity for a component (e.g., chemical or particle) to be filtered or isolated from a multi-component source composition, pore sizes larger than the component that needs to be transported across the membrane, but smaller than other components in the source composition that is to be retained in the feed flow channel. For example, in applications for hemodialysis, the pore size may be from about 3 nm to about 5 nm, thus retaining albumin in the source composition (blood) flow channel while allowing urea to traverse the pore to the isolate collection flow channel. In embodiments where selective filtering is mediated by an absorbent in the isolate collection material, the pore size may be larger, for example in the range of from about 100 nm to about 200 nm. In various embodiments, the size of pores in the wall is from about 1 nm to about 5 microns, or from about 2 nm to about 2 microns, or from about 3 nm to about 1 micron. In various embodiments, composites are microporous, having pores of an average diameter less than about 2 nanometers. In some embodiments, pores have an average diameter of about 3 nanometers. In some embodiments, composites may have hierarchical porosity, comprising a plurality of pore size distributions.

The porosity of the porous walls is preferably as high as possible to provide transport of materials through the wall, while affording acceptable mechanical stability. In various embodiments, porosity is from about 30% to about 90%, or from 50% to about 75%. Porosity is from about 30% to about 95%, preferably from about 50% to about 95%, more preferably from about 75% to about 95%. In general, without limiting the scope or function of the present technology, a higher porosity of the membrane wall may provide faster mass transport (more parallel pores in a given surface area) but at the cost of a rapidly decreasing mechanical stability.

In various embodiments, composites of the present technology have 1) a higher membrane area (compared to that of traditional one or two-dimensional membrane designs for the same volume), 2) a high-porosity membrane wall for enhanced mass transport (up to about 95% porosity compared to 20-70% in filter membranes known in the art), and 3) allow integrated forced mixing of both gas and liquid streams by the branching nature of the flow channels defined by the TPMS which boosts the filtration efficiency by actively mixing the liquid flowing through the flow channels (even under laminar flow conditions) thus maximizing the concentration gradient driven mass transport across the membrane wall. In various aspects, composites have ultra-high membrane area packing densities (up to 104 times larger compared to conventional 2D membrane designs) enabling ultrahigh permeation rates combined with high rejection for large molecules.

### Composition of Composites

Filtration composites may comprise any of a variety of materials, including polymers, ceramics, metals, and combinations thereof. The specific materials employed may, in various aspects, depend on the end use application and the method of manufacturing to achieve the desired functional characteristics of the composite. In general, composites comprise a wall structure material that forms the architecture of the composite (i.e., defines the channels) as described above and, optionally, a functional material, as further described below.

In various embodiments, composites (e.g., the wall structure materials thereof) comprise polymers. In various embodiments, any negative crosslinking polymerization system can be used, such as acrylic, methacrylate polymers, acetate, thiol-ene, or combinations thereof. In some embodiments, cationic polymerization systems may be used, such as epoxides and vinyl ethers. Such polymers include 1,6-hexanediol diacrylate polymer, carboxybetaine-dimethacrylate polymer, pentaerythirotal triacetate polymer, and mixtures thereof.

In various embodiments, composites (e.g., wall structure materials) may comprise metals. Examples include gold, silver, copper, platinum, carbon, silicon, titanium, vanadium, chromium, iron, cobalt, gallium, tin, tantalum, tungsten, lead, bismuth, and mixtures (e.g., alloys) thereof. In some embodiments, metals include gold, silver, and mixtures (alloys) thereof.

As noted above, composites may optionally comprise a functional material. In various embodiments, functional materials are incorporated in the wall structure material, are coated on the wall structure material or portions thereof, or both.

In various aspects, a functional material may provide one or more physical or chemical characteristics in the composite such as (a) creating one or more desired physical parameters (e.g., porosity), i.e., during manufacturing (as discussed further below), (b) improving filtration performance (e.g., efficiency), or (c) configuring the composite for an intended end-use application. For example, such functional materials may alter the physical or chemical characteristics of the walls so as to affect the passage of components (e.g., isolates) from a first channel to a second channel. In other aspects, composites may comprise functional materials to enhance the biocompatibility of the composites for use in methods of treating disorders (e.g., renal deficiency) in a human or animal subject. In some embodiments, composites may comprise functional materials, such as zitterionic polymers or other materials, to reduce or eliminate “fouling” wherein pores are otherwise wholly or partially filled with isolate or other materials reducing filtration efficiency of the composite.

In some embodiments, composites comprise functional materials to impart a desired wetting behavior to the surfaces of the flow channels, i.e., to provide a hydrophilic or hydrophobic surface. For example, in some composites used for gas/liquid separations, membrane walls comprise hydrophobic functional, so that the membrane pores are filled with gas (rather than liquid) thereby facilitate diffusion of a desired species from the gas phase to the liquid phase.

### Methods of Manufacturing

Filtration composites of the present technology may be made by any suitable method for forming interpenetrating structures, e.g., gyroid or other TPMS structures as described above. In various embodiments, composites are made by an additive manufacturing process, e.g., an additive printing process (3D printing). In general, such processes comprising forming a series of discrete layers successively formed one on top of another. In this fashion, the channels necessary to form the first channel and second channel are formed substantially simultaneously as each layer is printed materials are deposited by print heads of additive printing system. In various embodiments, the present technology provides methods for manufacturing three-dimensional interpenetrating structures including a first flow channel and a second flow channel defined and separated by porous walls, comprising (a) forming a three-dimensional interpenetrating wall structure by an additive printing process, and (b) processing the wall structure to form the nanopores in the walls.

TPMS membranes can be printed using any 3D printer technology that provides the required resolution (depending on the application, the required resolution defining membrane wall thickness and flow channel diameter may be in the range from a few micrometers to several millimeters) and sample size (from cubic centimeters to cubic meters). In various embodiments, the printed material (i.e., walls or membranes) can be transformed into a porous material by a self-organization process. For example, suitable printing technologies include but are not limited to Projection Micro Stereolithography (PuSL), Direct Ink Writing (DIW) and Selective Laser Sintering (SLS) or Melting (SLM) powder bed 3D printing.

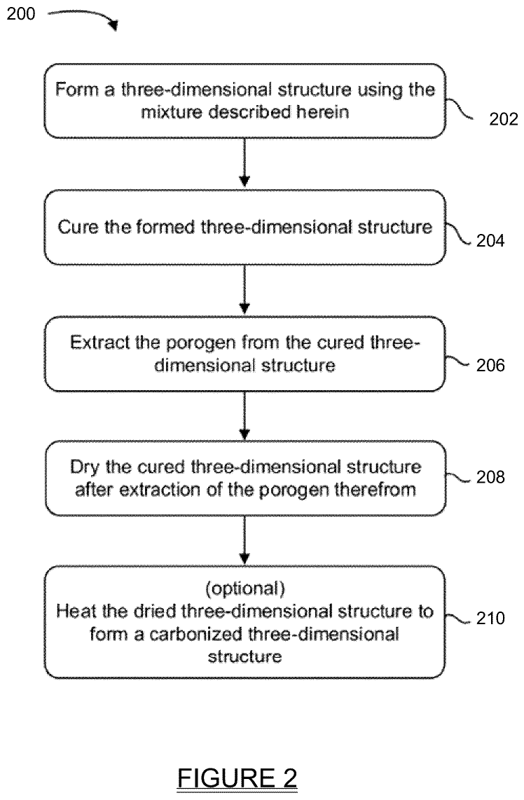

In various embodiments, as discussed above, composites comprising polymeric materials may be manufactured using additive printing processes. Such methods may comprise forming nanopores in a printed wall structure through a self-organization process, using a substrate ink comprising a polymer and a porogen. Such methods are generally outlined FIG. 2. As shown, methods (200) comprise forming (202) a three-dimensional structure using a substrate ink (mixture) comprising a polymer and porogen. The printed structure is then cured (204), followed by extraction of the porogen (206) to form pores in the structure. The structure may then be dried (208). Optionally, the structure may be heated (210) to form a carbonized structure. In some embodiments, the structure may be simultaneously formed and cured (i.e., combining steps 202 and 204), by light-mediated additive printing techniques. Such methods among those useful herein are described in U.S. Patent Application Publication No. 2020/0317870, Liang et al., published Oct. 8, 2020, the disclosure of which is incorporated herein by reference.

In various embodiments, methods for manufacturing employ a polymerization induced phase separation (PIPS) process where a photoresist that contains a non-reactive component phase (e.g., a porogen) separates due to changes in the solubility of the photoresist components during polymerization. During polymerization the initial homogeneous multi-component photoresist phase separates, generating a nanoscale structure that defines the pore morphology. The characteristic length scale of the features generated by this process depend on the nature of the photoresist components as well as on the diffusion and polymerization kinetics which in turn depend on the molecular structure, molecular weight, polymerization temperature, solvent choice, photoinitiator concentration, and photon flux. PIPS processes among those useful herein are described in Z. Dong et al, 3D Printing of Inherently Nanoporous Polymer via Polymerization-Induced Phase Separation, 2021, 12, 247.

Combining the print technology with the self-organization process provides deterministic control over the length scale spanning seven orders of magnitude, from a few 10 nm to several centimeters, thus making it possible to precisely control mass transport at the molecular level. Further, the specific design and synthesis of photoresist monomers allows integration of functional characteristics, such as anti-biofouling and blood compatibility for hemodialysis and other blood processing applications, and to engineer pore sizes for selectivity and permeability.

In various embodiments, the substrate ink comprises two main components: a polyfunctional monomer having at least one functional group amenable to polymerization (e.g., crosslinking); and a porogen. The mixture may include additional materials selected from the group consisting of polymerization initiators, polymerization inhibitors, photoabsorbers, and mixtures thereof.

In one approach, the mixture may include a polyfunctional monomer having at least two functional groups amenable to polymerization. For example, substrate ink may comprise a resin or a photoresist composition. Photoresist compositions may comprise a polyfunctional monomer having at least one functional group amenable to polymerization, a porogen, a photoinitiator and a polymerization inhibitor.

For example, in one embodiment, when a polyfunctional monomer having at least one functional group amenable to radical polymerization is combined with a polymerization initiator such as a photoinitiator, then the functional group of the polyfunctional monomer may be amenable to radiation-initiated polymerization. In general, a radiation curable functional group can be any suitable group or molecule that provides the desired effect upon curing, e.g., crosslinking, polymerization, etc. In one approach, a polyfunctional monomer has at least one functional group that when combined with an appropriate photoinitiator will cure under ultraviolet irradiation. The photoinitiator determines the response to light, thus, for example, a photoinitiator makes the resin sensitive towards UV. Thus, a polyfunctional monomer preferably has functional groups amenable to radical polymerization, but these functional groups preferably are not sensitive to UV in the absence of a photoinitiator. In some embodiments, a photoinitiator comprises irgacure.

In some embodiments, structural inks comprise a polyfunctional monomer having the following formula:

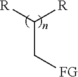

where each R is independently carbon, hydrogen, or a hydrocarbon moiety, and the functional group (FG) amenable to polymerization includes at least one of the following: acrylate, methacrylate, epoxide, olefin, isocyanate, systems including both mercapto and vinyl groups (e.g., mercaptan+olefin), etc. In some embodiments, the polyfunctional monomer may include a combination of different polyfunctional monomers having functional groups amenable to polymerization. In some approaches, the polyfunctional monomer may include a functionalized photoresist.

The substrate ink may comprise a porogen, which may be any component that can be used to create a porous structure and can be removed after solidification of the surrounding material, e.g., curing of the polyfunctional monomer. In one approach the porogen is a non-reactive component that can be subsequently removed after gelation of the mixture. For example, the porogen may be selected from the group consisting of polyethylene glyclol-400 (PEG-400), butanol, hexanol, triethylene-glycol-dimethyl ether, propylene carbonate, ethyl acetate, N-methyl-2-pyrrolidone (NMP), dimethylsulfoxide (DMSO), triethylene glycol, tetraethylene glycol, and combinations thereof.

In various embodiments, the substrate ink comprises a polymerization initiator, such as a crosslinking agent, or photoinitiator. In one approach, the polymerization initiator may be a thermal-active radical producing initiator. In another approach, the polymerization initiator may be a UV-active radical producing initiator. In embodiments comprising a cationic polymerization system, a UV-active cation may be used. The concentration of the polymerization initiator in the mixture may be in a range of about 0.05 wt % to less than 2.0 wt % of weight of total mixture. For example, the concentration of photoinitiator in the mixture is in a range of about 0.05% to about 1.0 wt % of total mixture.

The substrate ink may additionally comprise a photoabsorber. Photoabsorbers useful herein include azo dyes (e.g., Sudan 1), benzopheone, benzotriazole, salicylate, and mixtures thereof.

The substrate ink may additionally comprise a polymerization inhibitor. Polymerization inhibitors useful herein include tert-butylhydroquinone, hydroquinone, 4-methoxyphenol, phenothiazine, and mixtures thereof. In some embodiments, the substrate ink may include a polymerization inhibitor at an effective amount for inhibiting continuous polymerization of the polyfunctional monomer after irradiation but not at an effective amount to prevent formation of a three-dimensional structure by light-mediated additive manufacturing techniques.

As discussed above, with further reference to FIG. 2, manufacturing methods may include extracting the porogen (206) from the wet gel. In one approach, the extraction of the porogen (206) includes removing the porogen using a solvent exchange method. For example, the porogen polyethylene glycol may be exchanged with acetone or water. In some embodiments, the porogen may be removed by dissolution of the porogen into a co-solvent, or by removing the porogen by thermal decomposition.

The wet structure may then be dried (208) to form an aerogel. Conventional aerogel drying techniques may be used, including drying at ambient temperatures, drying at elevated temperatures, freeze drying, and supercritical drying.

In some embodiments, following drying the wet gel to form an aerogel (208), the aerogel may be heated to form a carbonized aerogel. Conventional aerogel carbonization techniques may be used, such as pyrolysis in an inert atmosphere.

In various embodiments, as discussed above, porous composites comprising metals may be manufactured using additive printing processes. For example, a direct ink writing (DIW) additive printing method, may be used to deposit filaments of rheologically tuned alloy “inks” made from desired metal powder mixtures, in a predefined geometry, to form a porous composite.

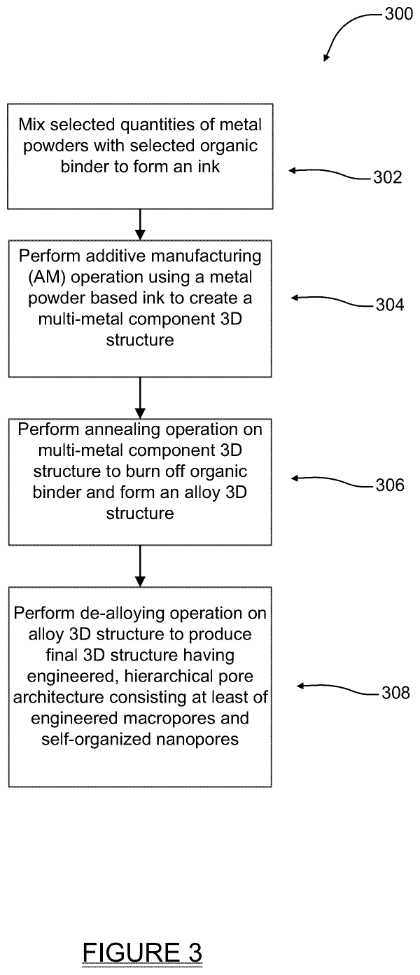

Such methods for making porous composites are generally outlined in FIG. 3. As shown, methods 300 comprise mixing (302) metal powders to form a substrate ink. An additive printing process (304) is then performed using the metal powder based ink to create a multi-metal structure. The structure is annealed (306) to remove organic components and form an alloy of the metal powders to form an alloyed structure. The structure is then de-alloyed (308) to produce the porous composite. Such methods among those useful herein are described in U.S. Patent Application Publication No. 2019/0118264, Qi et al., published Apr. 24, 2019, the disclosure of which is incorporated herein by reference.

In various embodiments, substrate inks comprise metal powders, gold particles, silver particles, and an organic binder. Nanoporous metals can be prepared from typical binary and ternary alloys, or even from multi-composition alloys (i.e., more than three different elements). The less noble elements have a lower standard electrode potential compared with the more noble elements for aqueous de-alloying process. Typical elements that can be used as less noble components are the following: Li, Na, Mg, Al, Si, K, Ca, Sc, Ti, V, Cr, Mn, Fe, Co, Ni, Cu, Zn, Ga, Ge, Sr, Zr, Nb, Mo, Cd, In, Sn, Pb, Bi and most or non-radioactive rare earth elements. Typical elements for the more noble elements to form nanoporous metals include Si, Ti, V, Cr, Mn, Fe, Co, Ni, Cu, Ga, Ge, Nb, Mo, Ru, Rh, Pd, Ag, Cd, Sn, Ta, W, Os, Ir, Pt, Au, Pb, and Bi. Other elements such as Be, B, P, S, As, and Se can be used as additive elements. The typical element compositional range for the less noble element of the alloy is from 5 to 99 atomic percent and the rest are the more noble elements.

The substrate ink may be formed by mixing metal powders (e.g., silver and gold) with a binder, to form a suspension. Specific quantities of the metal powders may be selected, along with the quantity of organic binder(s), to tune the rheological properties of the composition and to adjust the metal alloy composition formed during the subsequent annealing process. Alternatively, premade alloy particles with the desired metal component composition can be mixed with the binder from the substrate ink.

Printing may be performed using any suitable additive printing process, such as direct ink writing, selective laser sintering, selective laser melting, binder powder bed printing, fused deposition modeling, projection microstereolithography, electrophoretic deposition, screen printing, and inkjet printing.

After printing, the multi-metal structure may be heated to anneal the metal particles, forming the alloy by interdiffusion of the different metal particles, and burn off the organic binder. Depending on the alloy melting point, the annealing temperature varies. Generally, anywhere from about 0.99 to about 0.7 of the melting temperature of the alloy to be formed may be used as the annealing temperature. The annealing time may also be varied depending on the particle size used in the alloy and the annealing temperature. The annealing time may range from 1 hour to 24 hours. Smaller particles and higher annealing temperatures require a shorter time to form a homogenous alloy. For example, annealing of an Ag/Au alloy may, in some embodiments, be performed by heating the structure to about 850° C. using a heating rate of about 10° C./minute, for about twelve hours to remove the organic binder and allow the Ag and Au to form an alloy.

The de-alloying process comprises exposing the alloyed metal to an etching solution to remove the unwanted elements. For example, in some embodiments, a silver/gold alloy may be de-alloyed by submerging the annealed structure in concentrated nitric acid solution, e.g., for two days.

In various approaches, additive printing techniques provide control of printing features (e.g., wall structures) composites having a wide range of porosity, pore sizes and flow channel dimensions. For example, in various embodiments, use of UV-curable polymers allows use of light-curing techniques, including projection microstereolithography (PμSL) and direct laser writing via two photon polymerization (DLW-TPP), which can produce features on the order of 100 nm. In some embodiments, printing methods may provide composites having hierarchical porosity.

### Devices & Methods of Use

The present technology provides composites useful in a wide variety of processes comprising isolation, separation or other transport of materials between one or more liquid or gas compositions, generally referred to as “filtration” or “transport” herein (in a non-limiting fashion). In general, without limiting the scope or utility of the present technology, such processes may involve transport of one or more components from a first liquid or gas material (e.g., a multi-component liquid or gas stream) to a second liquid or gas material. In various embodiments, such transport may be characterized as filtration wherein a component is isolated or removed from a multi-component liquid or gas. In some aspects, such filtration may remove an undesired component from a liquid or gas (e.g., filtration of urea from blood in hemodialysis, or removing CO₂ from a combustion gas stream) or isolation of a desired component from a liquid or gas (e.g., isolation of rare earth elements from a source material).

In some embodiments, transport may control the flow of reactants or reaction products in an in situ chemical process, and not necessarily removal or separation of components from a previously created composition. For example, composites of the present technology may provide a controlled environment for reactions, such as gas/liquid reactions, wherein a gaseous component is supplied to a liquid component for chemical or physical processing. Accordingly, in some embodiments, composites may be useful for transfer of oxygen from source stream to blood, for oxygenation of hemoglobin.

End-use applications of the filtration composites of the present technology include any process in which isolation, separation or other transfer of a material (herein, a “permeate” or “isolate”) from a source composition or material is desired. In various aspects, methods comprise flowing a source composition through the composite, e.g., through a first channel of the composite, and collecting the isolate. Collecting the isolate may be effected by flowing a isolate-collection material through the composite, e.g., through a second channel of the composite. The isolate collection material may comprise a solvent or composition suitable for absorbing, adsorbing, dissolving, suspending or otherwise serving as a carrier for the isolate.

The present technology also provides devices comprising a filtration composite. For example, such devices comprise: a filtration composite; a mixture source in communication with the first flow channel; and an isolate collection media source in fluid communication with the second flow channel; wherein the porous walls are operable to selectively permit flow of the isolate from the mixture to the isolate collection media. Associated methods of use comprise pumping a mixture comprising an isolate through the first channel of the composite, pumping an isolate collection media through the second channel, wherein the isolate material flows from the first channel to the second channel through the porous pores. As noted above, in some embodiments, filtration or isolation of a component of a source mixture can be effected by use of an isolate collection media having an affinity for the component.

In some embodiments, such selectivity may not be from the structure of the membrane (pore walls) per se, but from the isolate collection material. For example, as further discussed below, high selectivity may be obtained for removal from CO₂/N₂ mixtures by use of a methylamine absorbent in the liquid isolate collection material.

Without limiting the scope or function of the present technology, in various embodiments composites of the present technology provide one or more benefits relative to filtration technologies known in the art, such as providing high filtration rates, high selectivity, minimizing adsorption of solutes in pores, and resistance to fouling (in applications where clogging of pores may be a concern). In various embodiments, such benefits are derived from the high porosity and high membrane surface area per packing volume, yielding high hydraulic permeance, narrow pore size distribution, and thin membrane and low-tortuosity pore structure. Branching of the gyroid flow channel architecture further increases the filtration efficiency and prevents fouling by inducing a turbulent flow pattern. The turbulent flow pattern maximizes the concentration gradient across the membrane wall that drives mass transport. Thus, in various aspects, composites of the present technology provide cross-flow filtration (tangential flow filtration), wherein components from the first and second material sources are mixed in the flow channels. Without such mixing, laminar flow conditions may lead to formation of boundary layers on both sides of the membrane, with depletion of the transfer species near the membrane surface in a source material channel, and enrichment of the transfer species near the membrane surface in the isolate flow channel. These depletion/enrichment layers reduce the concentration gradient across the membrane wall, thus reducing the driving force of filtration/separation.

### Hemodialysis

In various embodiments, filtration composites may be used for hemodialysis, e.g., for removing urea and other metabolic waste products (isolates) from human or other animal blood in subjects having a renal deficiency. In some embodiments, based on typical diffusion rates of metabolic waste such as urea in human plasma (about 10⁵ cm²/s) and a porous membrane wall thickness of from about 10 to about 30 microns (equal to the diffusion length of urea in plasma in about one second), a ten cubic centimeter 3D gyroid membrane device may filter the entire five-liter blood of a typical adult human in less than 15 minutes. Reducing the time required for a hemodialysis treatment by an order of magnitude while reducing the package size by a factor of ten (compared to today's high efficiency dialysis membranes (>1.5 m²)) allows the design of compact, implantable or wearable devices. The same performance improvement, 10 times faster separation/purification at 10 times smaller packing volume, can be expected for other applications like CO₂ separation.

In some embodiments, a filtration composite for use in hemodialysis comprises a polymeric system including carboxybetaine-dimethacrylate polymer (CBDA) and acrylonitrile (ACN). Composites may be printed using a substrate ink comprising CBDA, ACN, and polyethylene glycol (PEG400), as a porogen. For example, the polymer substrate ink may comprise about 37.5% CBDA (by weight of composition), about 37.5% PEG 400, and about 25% ACN. In some embodiments, the substrate ink further comprises an initiator, such as Irgacure 819. The ink substrate may also comprise an inhibitor, such as 4-methoxyphenol.

In another embodiment, substrate inks comprise CBDA and 1,6-hexane diacrylate (HDDA). Without limiting the scope or function of the present technology, inclusion of HDDA may increase the modulus, tensile strength and failure strain of the composite, as well as protein adsorption. CBDA provides blood compatibility and reduces or eliminates fouling of pores. The pore size of the composite may be modified by controlling the polymerization kinetics of the substrate ink and monomer structure.

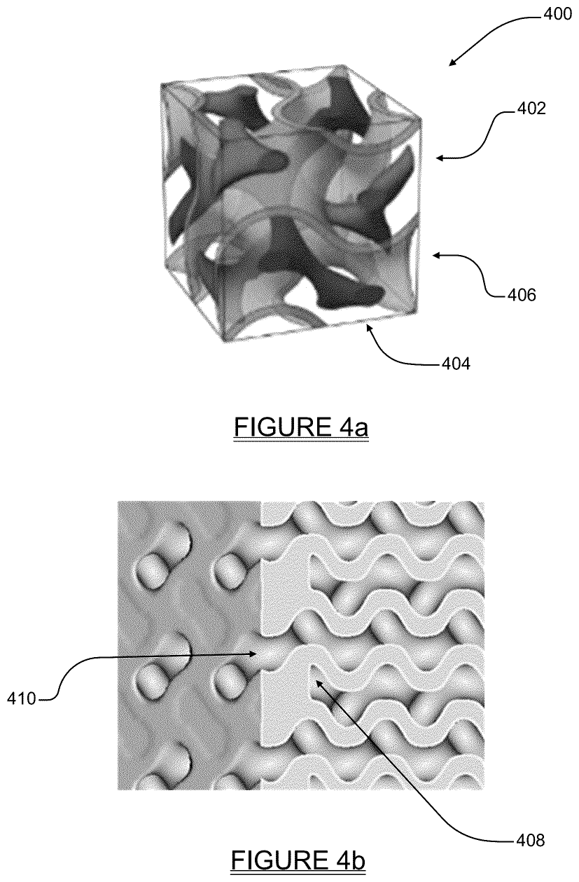

A representative composite (400) is depicted in FIG. 4a. The composite 400 comprises a first channel (402) and second channel (404), separated by membrane wall (406). As shown in FIG. 4b, independent flow channels can be constructed by closing one flow channel (second flow channel, 408) on each side of the composite. The first flow channel (410) remains open. The composite is cubic double-gyroid with 100-250 μm flow channel diameter size and 30 μm membrane wall thickness.

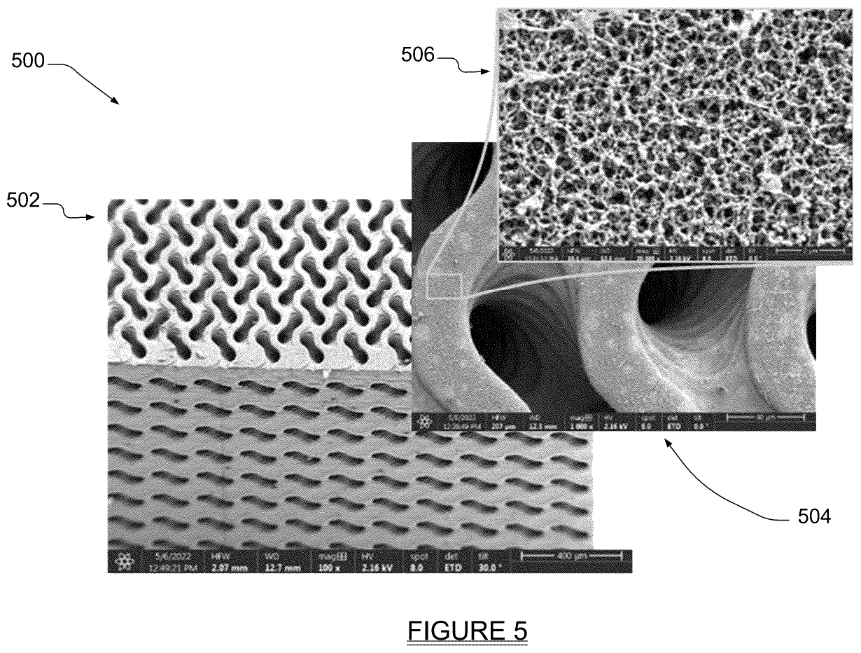

FIG. 5 provides scanning electron micrographs of a composite (500) showing varying levels of magnification: 100× (micrograph 502), 100× (micrograph 504) and 20,000× (micrograph 506).

### Carbon Dioxide Absorption

In various embodiments, filtration composites may be used for absorption of carbon dioxide from combustion gases and other sources. Such composites may be comprised and made as generally described above. Preferably, the wall surfaces are functionalized with a hydrophobic material to facilitate rapid mass transport of CO₂ through pores and reduce flooding of the pores. In various embodiments, composites comprise an HDDA polymer or other multifunctional acrylate ester. Acid or base treatments may be used to modify the nanopore surface with hydroxy and carboxy groups that act as reactive groups for functionalization with tri-methoxy-silanes.

Methods of use comprise flowing a CO₂-containing gas stream through the first channel of a composite. The isolate collection material, to collect CO₂, flows through the second channel. The isolate collection material may comprise a monoethanolamine solution.

Without limiting the scope or function of the present technology, filtration composites afford, in various aspects benefits relative to CO₂ sequestration technologies known in the art, including 1) ten times higher gas/liquid interfacial area (compared to that of traditional packings for the same volume), 2) high-porosity membrane wall for enhanced mass transport (up to about 95% porosity compared to 20-70% in state-of-the-art designs), and 3) integrated forced mixing of both gas and liquid streams by the branching nature of the TPMS (e.g., gyroid) flow channel architecture which increases the concentration gradient-driven CO₂ diffusion rate across the membrane. In various aspects, filtration composites improve the energy efficiency of CO₂ capture from combustion streams (e.g., fossil fuel power plants) by increasing the CO₂ absorbing capacity of the absorber by improving the CO₂ mass transport between the CO₂ rich flue gas and the CO₂ lean absorber as well as the CO₂ rich absorber and CO₂ gas phase on the stripper side. Together these features may increase the energy efficiency of CO₂ capture by increasing the CO₂ loading of the absorber (isolate collection) liquid while at the same time enabling more compact designs. The captured CO₂ may be used as feedstock for electrochemical CO₂ reduction in the production of commodity chemicals.

### Rare Earth Element Production

In various embodiments, filtration composites may be used for rare earth element (REE) production from primary ores and secondary sources. Such REEs include yttrium, lanthanum, cerium, scandium, praseodymium, dysprosium, neodymium and europium. Filtration composites useful in methods for producing REEs may be comprised and made as generally described above. In various embodiments, lanmodulin (LanM) is used as a functional material, which may be immobilized on the surface of pores. LanM is a natural REE-selective protein.

### Non-Limiting Listing of Exemplary Embodiments

The present technology includes the following exemplary embodiments.

Embodiment A1. A material processing composite comprising a first flow channel and a second flow channel defined and separated by porous walls, wherein the first flow channel and the second flow channels have a three-dimensional interpenetrating structure.

Embodiment A2. The composite of Embodiment 1, wherein the first flow channel and the second flow channel have a triply periodic minimal surface structure.

Embodiment A3. The composite of Embodiment 2, wherein the triply periodic minimal surface structure is a gyroid, double gyroid, Schwartz, kelvin foam, octet truss, Kagome lattice, Neovice, N14, N26, N38, diamond, or double diamond surface structure.

Embodiment A4. The composite of any of the preceding A-embodiments, wherein at least one of the first flow channel and the second flow channel has a cross sectional diameter of from about 1 μm to about 10,000 μm, or from about 5 μm to about 5,000 μm, or from about 10 μm to about 1,000 μm, or from about 50 μm to about 500 μm.

Embodiment A5. The composite of any of the preceding A-embodiments, wherein the porous walls have a thickness of from about 5 μm to about 1,000 μm, preferably 10 μm to about 500 μm, more preferably 10 μm to about 100 μm.

Embodiment A6. The composite of any of the preceding A-embodiments, wherein the porous walls comprise a plurality of pores having a pore size of from about 0.001 μm to about 5 μm, preferably from about 0.003 μm to about 1 μm, more preferably from about 0.003 μm to about 0.5 μm.

Embodiment A7. The composite of any of the preceding A-embodiments, wherein the porous walls have a porosity of from about 30% to about 95%, preferably from about 50% to about 95%, more preferably from about 75% to about 95%.

Embodiment A8. The composite of any of the preceding A-embodiments, wherein the porous walls comprise a polymer, metal or ceramic.

Embodiment A9. The composite of any of Embodiment A8, wherein the porous walls comprise a metal selected from the group consisting of gold, silver, copper, platinum, carbon, silicon, titanium, vanadium, chromium, iron, cobalt, gallium, tin, tantalum, tungsten, lead, bismuth and mixtures thereof.

Embodiment A10. The composite of Embodiment A9, wherein the porous walls comprise a metal selected from the group consisting of silver, gold, and combinations thereof.

Embodiment A11. The composite of Embodiment A9, wherein the porous walls comprise an acrylate, methacrylate polymer, acetate polymer or combinations thereof, such as a polymer selected from the group consisting of 1,6-hexane diacrylate polymer, carboxybetaine-dimethacrylate polymer, pentaerythirotal triacetate polymer, and combinations thereof.

Embodiment A12. The composite of any of the preceding A-embodiments, wherein the porous walls comprise a functional material.

Embodiment A13. The composite of any of the preceding A-embodiments, configured for use in hemofiltration, molecular filtration, gas purification, energy storage, or chemical conversion.

Embodiment A14. A filtration device for filtering a mixture comprising a component material, the device comprising:
a composite of any of the preceding A-embodiments;
a mixture source in communication with the first flow channel; and
a component material collection media source in fluid communication with the second flow channel;
wherein the porous walls are operable to selectively permit flow of the component material from the mixture.

Embodiment A15. A method for filtering a mixture comprising a component material using the hemofiltration device of Embodiment A14, the method comprising:

A method for filtering a mixture comprising a component material using the hemofiltration device of Embodiment A14, the method comprising:
pumping the mixture through the first channel;
pumping a component material collection media through the second channel;
wherein the component material flows from the first channel to the second channel through the porous pores.

Embodiment B1. A hemofiltration composite comprising a first flow channel and a second flow channel defined and separated by porous walls, wherein the first flow channel and the second flow channels have a an interpenetrating three-dimensional triply periodic minimal surface structure.

Embodiment B2. The hemofiltration composite of Embodiment 2, wherein the triply periodic minimal surface structure is a gyroid or Schwartz surface structure.

Embodiment B3. The hemofiltration composite of any of the preceding B-embodiments, wherein at least one of the first flow channel, the second flow channel has a cross sectional dimension of from about 200 μm to about 5,000 μm, or from about 300 μm to about 1,000 μm.

Embodiment B4. The hemofiltration composite of any of the preceding B-embodiments, wherein the porous walls have a thickness of from about 10 μm to about 500 μm, preferably 25 μm to about 100 μm.

Embodiment B5. The hemofiltration composite of any of the preceding B-embodiments, wherein the porous walls comprise a plurality of pores having a pore size of from about 0.001 μm to about 0.1 μm, preferably from about 0.003 μm to about 0.01 μm.

Embodiment B6. The hemofiltration composite of any of the preceding B-embodiments, wherein the porous walls have a porosity of from about 30% to about 95%, more preferably from about 50% to about 95%.

Embodiment B7. The hemofiltration composite of any of the preceding B-embodiments, wherein the porous walls comprise a carboxybetaine-dimethacrylate polymer, preferably also comprising a1,6-hexane diacrylate polymer.

Embodiment B8. The hemofiltration composite of Embodiment A10, wherein the porous walls comprise a polymer comprising metal selected from the group consisting of silver, gold, and combinations thereof.

Embodiment B9. A hemofiltration device for filtering a waste material from blood, comprising:
a composite of any of the preceding B-embodiments;
a blood source in fluid communication with the first flow channel; and
a waste material collection fluid source in fluid communication with the second flow channel;
wherein the porous walls are operable to selectively permit flow of the waste material from the blood.

Embodiment B10. A method for filtering blood having a waste material component using the hemofiltration device of Embodiment B9, comprising:
pumping the blood through the first channel;
pumping a waste collection fluid through the second channel;
wherein the waste material component flows from the first channel to the second channel through the porous pores.

Embodiment C1. A gas filtration composite for extracting carbon dioxide from a combustion gas stream, comprising a first flow channel and a second flow channel formed and separated by porous walls, wherein the first flow channel and the second flow channels have a an interpenetrating three-dimensional triply periodic minimal surface structure.

Embodiment C2. The gas filtration composite of Embodiment 2, wherein the triply periodic minimal surface structure is a gyroid or Schwartz surface structure.

Embodiment C3. The gas filtration composite of any of the preceding C-embodiments, wherein at least one of the first flow channel, the second flow channel has a cross sectional dimension of from about 50 μm to about 1,000 μm, or from about 100 μm to about 500 μm.

Embodiment C4. The gas filtration composite of any of the preceding C-embodiments, wherein the porous walls have a thickness of from about 10 μm to about 50 μm, preferably 25 μm to about 35 μm.

Embodiment C5. The gas filtration composite of any of the preceding C-embodiments, wherein the porous walls comprise a plurality of pores having a pore size of from about 0.001 μm to about 1 μm, preferably from about 0.01 μm to about 0.2 μm.

Embodiment C6. The gas filtration composite of any of the preceding C-embodiments, wherein the porous walls have a porosity of from about 30% to about 95%, more preferably from about 50% to about 95%.

Embodiment C7. The gas filtration composite of any of the preceding C-embodiments, wherein the porous walls comprise a 1,6-hexane diacrylate polymer.

Embodiment C8. The gas filtration composite of Embodiment C10, wherein the porous walls comprise a metal selected from the group consisting of silver, gold, and combinations thereof.

Embodiment C9. A filtration device for filtering a combustion gas stream comprising carbon dioxide, the device comprising:
a composite of any of the preceding C-embodiments;
a combustion gas source in communication with the first flow channel; and
a carbon dioxide collection media source in fluid communication with the second flow channel;
wherein the porous walls are operable to selectively permit flow of the carbon dioxide from the combustion gas.

Embodiment C10. A method for filtering a combustion gas comprising carbon dioxide using the filtration device of Embodiment C9, the method comprising:
pumping the combustion gas through the first channel;
pumping a carbon dioxide collection media through the second channel;
wherein the carbon dioxide flows from the first channel to the second channel through the porous pores.

Embodiment D1. A method for making a material processing composite having a three-dimensional interpenetrating structure including a first flow channel and a second flow channel defined and separated by porous walls, the method comprising forming the porous walls by an additive printing process using a substrate ink.

Embodiment D2. The method of Embodiment D1, wherein the additive printing process comprises projection micro stereolithography, direct ink writing, selective laser sintering, selective laser melting, or powder bed three-dimensional printing.

Embodiment D3. The method of Embodiment D2, wherein the additive printing process is projection micro stereolithography.

Embodiment D4. The method of any of the preceding D-embodiments, wherein the porous walls comprise a polymer metal or ceramic.

Embodiment D5. The method of Embodiment D4, wherein the porous walls comprise an acrylate or methacrylate polymer, such as a polymer selected from the group consisting of 1,6-hexane diacrylate polymer, carboxybetaine-dimethacrylate polymer, pentaerythirotal triacetate polymer, and mixtures thereof.

Embodiment D6. The method according to Embodiment D5, further comprising forming pores in the porous walls.

Embodiment D7. The method of Embodiment D4, wherein the forming of pores comprises a self-organization process.

Embodiment D8. The method of Embodiment D5, wherein the self-organization process is polymerization induced phase separation.

Embodiment D9. The method of any of Embodiment D5-D8, wherein the substrate ink comprises a monomer and a porogen, wherein the forming comprises printing a wall structure using the additive printing process; curing the wall structure to form a cured structure; and extracting the porogen from the cured structure to form the porous walls.

Embodiment D10. The method of Embodiment D9, wherein the porogen is selected from the group consisting of polyethylene glycol, butanol, hexanol, triethylene-glycol-dimethyl ether, propylene carbonate, ethyl acetate, NMP, DMSO, triethylene glycol, tetraethylene glycol, and combinations thereof.

Embodiment D11. The method of any of Embodiment D5-D8, wherein the substrate ink further comprises a photoinitiator.

Embodiment D12. The method of any of Embodiment D5-D8, wherein the substrate ink further comprises a polymerization inhibitor.

Embodiment D13. The method of any of Embodiment D9-D12, wherein the additive printing process is projection micro stereolithography.

Embodiment D14. The method of Embodiment D4, wherein the porous walls comprise a metal selected from the group consisting of silver, gold, and combinations thereof.

Embodiment D15. The method of any of Embodiment D14, wherein the substrate ink comprises a metal powder comprising a first metal powder, a second metal powder and a binder, wherein the forming comprises printing a wall structure using the additive printing process; annealing the wall structure to form an alloyed structure; and dealloying the wall to form the porous walls.

Embodiment D16. The method of any of Embodiment D14-D15, wherein the additive printing process is direct ink writing.

### Non-limiting Discussion of Terminology

The headings (such as “Introduction” and “Summary”) and sub-headings used herein are intended only for general organization of topics within the present disclosure, and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The description and specific examples, while indicating embodiments of the technology, are intended for purposes of illustration only and are not intended to limit the scope of the technology. Equivalent changes, modifications and variations of specific embodiments, materials, compositions and methods may be made within the scope of the present technology, with substantially similar results. Moreover, recitation of multiple embodiments having stated features is not intended to exclude other embodiments having additional features, or other embodiments incorporating different combinations of the stated features. For example, a component which may be A, B, C, D or E, or combinations thereof, may also be defined, in some embodiments, to be A, B, C, or combinations thereof. Specific examples are provided for illustrative purposes of how to make and use the compositions and methods of this technology and, unless explicitly stated otherwise, are not intended to be a representation that given embodiments of this technology have, or have not, been made or tested.

As used herein, the words “prefer” or “preferable” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components or process steps, the present technology also specifically includes embodiments consisting of, or consisting essentially of, such materials, components or processes excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein. Further, as used herein the term “consisting essentially of” recited materials or components envisions embodiments “consisting of” the recited materials or components.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters.

Unless otherwise stated herein, or evident in context, all percentages are by weight of composition.

As referred to herein, ranges are, unless specified otherwise, inclusive of endpoints and include disclosure of all distinct values and further divided ranges within the entire range. Thus, for example, a range of “from A to B” or “from about A to about B” is inclusive of A and of B. Further, the phrase “from about A to about B” includes variations in the values of A and B, which may be slightly less than A and slightly greater than B; the phrase may be read be “about A, from A to B, and about B.” The phase “less than about x” means about X or less than X. Similarly, the phrase “greater than about X” means about X or greater than X. Disclosure of values and ranges of values for specific parameters (such as temperatures, molecular weights, weight percentages, etc.) are not exclusive of other values and ranges of values useful herein.

It is also envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A material processing composite comprising a first flow channel and a second flow channel defined and separated by porous walls, wherein the first flow channel and the second flow channels have a three-dimensional interpenetrating structure.

2. The composite of claim 1, wherein the first flow channel and the second flow channel have a triply periodic minimal surface structure selected from the group consisting of gyroid, double gyroid, Schwartz, kelvin foam, octet truss, Kagome lattice, Neovice, N14, N26, N38, diamond, or double diamond surface structure.

3. The composite of claim 1, wherein at least one of the first flow channel and the second flow channel has a cross sectional diameter of from about 10 μm to about 1,000 μm.

4. The composite of claim 1, wherein the porous walls comprise a plurality of pores having a pore size of from about 0.003 μm to about 1 μm.

5. The composite of claim 1, wherein the porous walls comprise a polymer, metal or ceramic.

6. The composite of claim 1, wherein the porous walls comprise an acrylate, methacrylate polymer, acetate polymer or combinations thereof, such as a polymer selected from the group consisting of 1,6-hexane diacrylate polymer, carboxybetaine-dimethacrylate polymer, pentaerythirotal triacetate polymer, and combinations thereof.

7. The composite of any of the preceding claim 2, configured for use in hemofiltration, molecular filtration, gas purification, energy storage, or chemical conversion.

8. A filtration device for filtering a mixture comprising a component material, the device comprising:
a composite comprising a first flow channel and a second flow channel defined and separated by porous walls, wherein the first flow channel and the second flow channels have a three-dimensional interpenetrating structure;
a mixture source in communication with the first flow channel; and
a component material collection media source in fluid communication with the second flow channel;
wherein the porous walls are operable to selectively permit flow of the component material from the mixture.

9. The filtration device of claim 8, wherein the first flow channel and the second flow channel have a triply periodic minimal surface structure selected from the group consisting of gyroid a gyroid or Schwartz surface structure.

10. The filtration device of claim 9, wherein at least one of the first flow channel, the second flow channel has a cross sectional dimension of from about 200 μm to about 5,000 μm, or from about 300 μm to about 1,000 μm.

11. The filtration device of claim 9, wherein the porous walls comprise a plurality of pores having a pore size of from about 0.001 μm to about 0.1 μm, preferably from about 0.003 μm to about 0.01 μm.

12. The filtration device of claim 9, wherein the porous walls comprise a carboxybetaine-dimethacrylate polymer and a 1,6-hexane diacrylate polymer.

13. A method for making a material processing composite having a three-dimensional interpenetrating structure including a first flow channel and a second flow channel defined and separated by porous walls, the method comprising forming the porous walls by an additive printing process using a substrate ink.

14. The method of claim 13, wherein the additive printing process comprises projection micro stereolithography, direct ink writing, selective laser sintering, selective laser melting, or powder bed three-dimensional printing.

15. The method of any of claim 13, wherein the porous walls comprise a polymer metal or ceramic.

16. The method of claim 15, wherein the porous walls comprise an acrylate or methacrylate polymer, such as a polymer selected from the group consisting of 1,6-hexane diacrylate polymer, carboxybetaine-dimethacrylate polymer, pentaerythirotal triacetate polymer, and mixtures thereof.

17. The method according to claim 16, further comprising forming pores in the porous walls through polymerization induced phase separation.

18. The method of any of claim 17, wherein the substrate ink comprises a monomer and a porogen, wherein the forming comprises printing a wall structure using the additive printing process; curing the wall structure to form a cured structure; and extracting the porogen from the cured structure to form the porous walls.

19. The method of claim 18, wherein the porogen is selected from the group consisting of polyethylene glycol, butanol, hexanol, triethylene-glycol-dimethyl ether, propylene carbonate, ethyl acetate, NMP, DMSO, triethylene glycol, tetraethylene glycol, and combinations thereof.

20. The method of claim 13, wherein the porous walls comprise a metal selected from the group consisting of silver, gold, and combinations thereof, and the substrate ink comprises a metal powder comprising a first metal powder, a second metal powder and a binder, wherein the forming comprises printing a wall structure using the additive printing process; annealing the wall structure to form an alloyed structure; and dealloying the wall to form the porous walls.
